(19) United States
(12) Patent Application Publication
(10) Pub. No.: US 2007/0075639 A1
(43) Pub. Date: Apr. 5, 2007

(54) PLASMA DISPLAY PANEL AND METHOD OF MANUFACTURING THE SAME

(76) Inventors: Byung Hwa SEO, Seoul (KR); Je Seok Kim, Gyeonggi-do (KR); Byung Gil Ryu, Gyeonggi-do (KR); Won Seok Jeon, Gyeonggi-do (KR)

Correspondence Address: FLESHNER & KIM, LLP, P.O. BOX 221200, CHANTILLY, VA, 20153, US

(21) Appl. No.: 11/536,840

(22) Filed: Sep. 29, 2006

(30) Foreign Application Priority Data
Sep. 30, 2005 (KR) 10-2005-0092584

(51) Int. Cl. H01J 17/49

(52) U.S. Cl. 313/582

(57) ABSTRACT

A plasma display panel and a method of manufacturing the same are disclosed. The plasma display panel includes a plurality of partition walls formed on a substrate such that the partition walls are arranged at predetermined intervals, auxiliary partition walls formed between the neighboring partition walls on the substrate, and at least one groove, having a predetermined depth, formed at the upper part of each auxiliary partition wall.

This application claims the benefit of Korean Patent Application No. 10-2005-0092584, filed on Sep. 30, 2005, which is hereby incorporated by reference as if fully set forth herein.

### BACKGROUND OF THE INVENTION

1. Field of the Invention

The present invention relates to a plasma display panel and a method of manufacturing the same.

2. Discussion of the Related Art

Generally, a display having small thickness and large area may be referred to as a plasma display panel (hereinafter, referred to as a “PDP”).

The PDP includes a front glass substrate and a rear glass substrate. On the front glass substrate are sequentially formed a plurality of sustain electrodes, which are arranged in pairs, a dielectric layer, and an MgO layer.

On the rear glass substrate are formed a plurality of address electrodes, on which a dielectric layer is formed. On the dielectric layer are formed partition walls to partition rear glass substrate into discharge cells. A fluorescent layer is formed in the discharge cells.

The front glass substrate and the rear glass substrate are attached to each other such that the sustain electrodes of the front glass substrate are perpendicular to the address electrodes of the rear glass substrate. Gas is encapsulated in a space defined between the two substrates.

In the PDP with the above-stated construction, the fluorescent layer is formed normally using a dispensing method.

The dispensing method is advantageous in that fluorescent substance is finely applied in the discharge cells between the respective partition walls. However, the dispensing method is disadvantageous in that the fluorescent substance is not perfectly or uniformly applied at the region where the application of the fluorescent substance is initiated.

In order to solve this problem, there has been proposed a method of forming auxiliary partition walls between the respective partition walls so as to decrease the difference in height between a dispenser and a substrate, thereby improving the application defectiveness of the fluorescent substance.

According to a conventional art, as shown in FIG. 1, auxiliary partition walls 3 of a substrate 2 are formed such that the auxiliary partition walls 3 are perpendicular to the longitudinal direction of partition walls 1. The auxiliary partition walls 3 are disposed at opposite ends of the partition walls 1.

The auxiliary partition walls 3 have a height less than that of the partition walls 1.

As shown in FIG. 2, the auxiliary partition walls 3 serve to decrease the difference in height between a dispenser 5 and the substrate 2. As a result, the application defectiveness of fluorescent substance is improved at the region where the application of the fluorescent substance is initiated.

The dispenser 5 is moved along the partition walls 1 to discharge fluorescent paste 4 in the direction of the substrate 2.

When the auxiliary partition walls 3 are not provided, the difference in height between the substrate 2 and the dispenser 5 is large with the result that the fluorescent paste 4 is excessively discharged at the region where the application of the fluorescent substance is initiated. When the auxiliary partition walls 3 are provided, on the other hand, the difference in height between the substrate 2 and the dispenser 5 is decreased with the result that the fluorescent paste 4 is prevented from being excessively discharged at the region where the application of the fluorescent substance is initiated.

When the auxiliary partition walls 3 are provided, however, the fluorescent paste 4 discharged to the auxiliary partition walls 3 may flow from the top surfaces of the auxiliary partition walls 3 in the direction of the discharged cells depending upon the application amount of the fluorescent paste 4.

As a result, a fluorescent layer is nonuniformly formed in discharge cells, and therefore, the brightness of the PDP is lowered during the discharge of electricity.

### SUMMARY OF THE INVENTION

Accordingly, the present invention is directed to a plasma display panel and a method of manufacturing the same that substantially obviate one or more problems due to limitations and disadvantages of the related art.

An object of the present invention is to provide a plasma display panel and a method of manufacturing the same that is capable of accomplishing uniform application of fluorescent substance in discharge cells, thereby effectively preventing the brightness of the plasma display panel from being lowered.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a plasma display panel includes a plurality of partition walls formed on a substrate such that the partition walls are arranged at predetermined intervals, auxiliary partition walls formed between the neighboring partition walls on the substrate, and at least one groove, having a predetermined depth, formed at the upper part of each auxiliary partition wall.

The auxiliary partition walls may be arranged in the direction perpendicular to the longitudinal direction of the partition walls, and the auxiliary partition walls may be spaced a predetermined distance from opposite ends of the partition walls toward the middles of the partition walls.

The top surfaces of the auxiliary partition walls may have a height lower than that of the top surfaces of the partition walls. Also, the grooves may have side surfaces perpendicular to the bottom surfaces of the grooves. Alternatively, the grooves may have side surfaces at a predetermined angle to the bottom surfaces of the grooves.

The grooves may have flat bottom surfaces. Alternatively, each groove may have a bottom surface at which at least one sub groove is formed such that the bottom surface of each groove is formed in a concavo-convex shape.

The grooves may be constructed in an open-type structure in which the circumferences of the grooves are partially opened to the outside. In this case, the side surfaces of the partition walls may be located at the opened regions of the open-type structure grooves.

A plasma display panel includes a plurality of partition walls formed on a substrate such that the partition walls are arranged at predetermined intervals, auxiliary partition walls formed on a non-discharge region of the substrate, and at least one groove, having a predetermined depth, formed at the upper part of each auxiliary partition wall.

The partition wall may divide into fluorescent regions that are different from each other. Also, a fluorescent paste may be formed in the auxiliary partition walls.

The auxiliary partition walls may have a height lower than the partition walls. Also, the auxiliary partition walls have a width wider than the partition walls.

The auxiliary partition walls may be arranged at least one end region to the longitudinal direction of the partition walls.

In another aspect of the present invention, a method of manufacturing a plasma display panel includes forming a plurality of partition walls on a substrate such that the partition walls are arranged at predetermined intervals, forming auxiliary partition walls between the neighboring partition walls on the substrate, and forming grooves at the upper parts of the auxiliary partition walls to a predetermined depth.

The step of forming grooves may include applying groove-forming paste having a predetermined height to the edge regions of the top surfaces of the auxiliary partition walls, and drying the groove-forming paste to form grooves at the upper parts of the auxiliary partition walls.

The step of forming grooves may include forming masks having a predetermined pattern on the top surfaces of the auxiliary partition wall, and partially etching the upper parts of the auxiliary partition walls to a predetermined thickness according to the pattern of the masks such that grooves are formed at the upper parts of the auxiliary partition walls.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating partition walls and auxiliary partition walls of a general plasma display panel;

FIG. 2 is a view illustrating the function of the auxiliary partition walls shown in FIG. 1;

FIGS. 3A and 3B are views illustrating partition walls and auxiliary partition walls of a plasma display panel according to a first embodiment of the present invention; and

FIG. 4 is a view illustrating partition walls and auxiliary partition walls of a plasma display panel according to a second embodiment of the present invention.

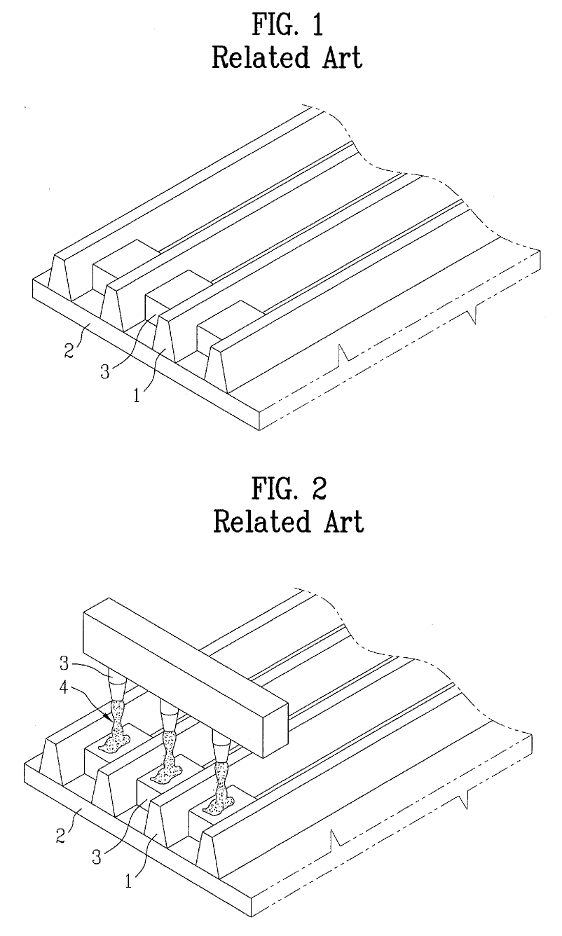

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

The concept of the present invention is to form grooves at the upper parts of auxiliary partition walls such that the nonuniform initial discharge amount of fluorescent paste is received in the grooves at the time of applying the fluorescent paste, whereby the fluorescent paste is uniformly applied in discharge cells.

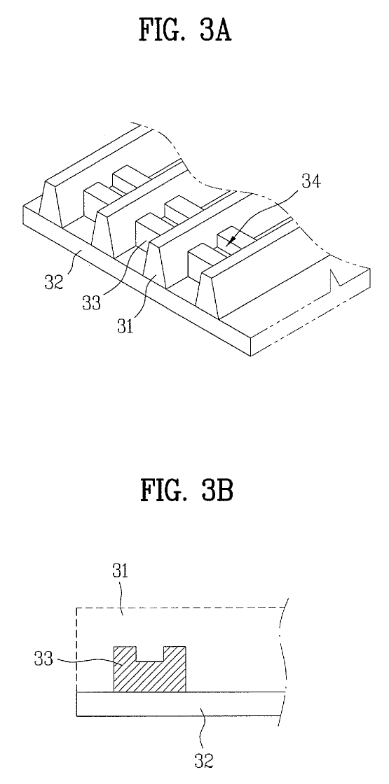

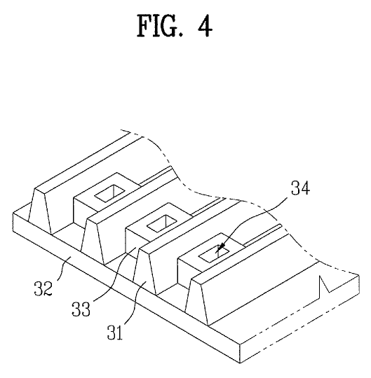

FIGS. 3A and 3B are views illustrating partition walls and auxiliary partition walls of a plasma display panel according to a first embodiment of the present invention, and FIG. 4 is a view illustrating partition walls and auxiliary partition walls of a plasma display panel according to a second embodiment of the present invention.

As shown in FIGS. 3A, 3B, and 4, a plurality of partition walls 31 are formed on a rear glass substrate 32 such that the partition walls 31 are arranged at predetermined intervals.

Auxiliary partition walls 33 are formed between the neighboring partition walls 31 on the rear glass substrate 32. At the upper part of each auxiliary partition wall 33 is formed at least one groove 34 having a predetermined depth.

The auxiliary partition walls 33 are arranged in the direction perpendicular to the longitudinal direction of the partition walls 31. Also, the auxiliary partition walls 33 are spaced a predetermined distance from opposite ends of the partition walls 31 toward the middles of the partition walls 31.

Preferably, the predetermined distance from the opposite ends of the partition walls 31 toward the middles of the partition walls 31 is approximately 0.5 mm or more.

The height of the top surfaces of the auxiliary partition walls 33 is lower than that of the top surfaces of the partition walls 31. Preferably, the difference in height between the auxiliary partition walls 33 and the partition walls 31 is approximately 2 to 30 um. The upper width of the auxiliary partition walls 33 may be approximately 0.02 to 10 mm.

Also, the side surfaces of the grooves 34 may be perpendicular to the bottom surfaces of the grooves 34. Alternatively, the side surfaces of the grooves 34 may be at a predetermined angle to the bottom surfaces of the grooves 34.

The bottom surfaces of the grooves 34 may be flat. Alternatively, the bottom surface of each groove 34 may have at least one sub groove such that the bottom surface of each groove 34 is formed in a concavo-convex shape.

Furthermore, the grooves 34 may be constructed in an open-type structure in which the circumferences of the grooves 34 are partially opened to the outside as shown in FIG. 3A. Alternatively, the grooves 34 may be constructed in a closed-type structure in which the circumferences of the grooves 34 are not opened to the outside as shown in FIG. 4.

When the grooves 34 are constructed in the open-type structure as shown in FIG. 3A, it is preferable that the side surfaces of the partition walls be located at the opened regions of the open-type structure grooves 34.

The depth of the grooves 34 may be approximately 1 to 90 um from the top surfaces of the grooves.

The grooves 34 of the auxiliary partition walls 33 serve to receive the initial application amount of fluorescent paste so as to accomplish uniform application of the fluorescent paste.

As can be seen from the above description, the partition wall structure for plasma display panel according to the present invention is a structure in which the auxiliary partition walls 33 are located at the edge of the rear glass substrate 32, and the grooves 34 are formed at the upper parts of the auxiliary partition walls 33.

The grooves 34 are constructed such that the grooves 34 are formed in a “U” or “V” shape along the vertical direction and the grooves 34 have a predetermined depth.

Specifically, the grooves 34 are formed at the upper parts of the auxiliary partition walls 33 located at the edge of the rear glass substrate 32 such that the initial application amount of fluorescent paste is received in the grooves to prevent the fluorescent paste from flowing out of the auxiliary partition walls 33.

In the auxiliary partition walls 33 having the open-type structure as shown in FIG. 3A, the opened regions of the auxiliary partition walls 33 are located at the partition walls 31. Consequently, the fluorescent paste received in the grooves 34 does not flow out of the auxiliary partition walls 33.

The capacity of the groove 34 formed at each auxiliary partition wall 33 is the minimum volume to receive the fluorescent paste. The receiving degree of the fluorescent paste is changed depending upon the viscosity of the fluorescent paste.

As the auxiliary partition walls 33 having the grooves are formed at the edge of the rear glass substrate 32 as described above, the nonuniformity of the application amount of the fluorescent paste generated when the application of the fluorescent paste is initiated is prevented.

The above-stated construction will be described in detail. The auxiliary partition walls 33 are located at the edge of the rear glass substrate 32. The auxiliary partition walls 33 serve to decrease the difference in height between dispenser to inject the fluorescent paste and the rear glass substrate 32 such that the application amount of the fluorescent paste which is nonuniformly applied when the application of the fluorescent paste is initiated is lowered to a predetermined level or less.

The groove 34 formed at the upper part of each auxiliary partition wall 33 has a predetermined capacity, and therefore, the initial application amount of the fluorescent paste is received in the grooves 34 of the auxiliary partition wall 33.

Specifically, it is necessary that the dispenser apply the fluorescent paste into the discharge cells between the respective partition walls 31 such that the fluorescent paste has a uniform thickness in the respective discharge cells.

However, the initial application amount of the fluorescent paste is not uniform. In order to solve this problem, according to the present invention, the auxiliary partition walls 33 are formed such that the nonuniformity of application of the fluorescent paste due to the distance between nozzle parts of the dispenser and the substrate can be decreased to the minimum, and the grooves 34 are formed at the auxiliary partition walls 33 such that the initial application amount of the fluorescent paste nonuniformly discharged can be received in the grooves 34.

Subsequently, the dispenser is moved in the direction of the discharge cells such that the fluorescent paste can be uniformly applied in the discharge cells.

Meanwhile, it is preferable that the grooves 34 of the auxiliary partition walls 33 be located at the position where the application of the fluorescent paste from the nozzle parts of the dispenser is initiated.

Also, the grooves 34 of the auxiliary partition walls 33 are constructed in the open-type structure or in the closed-type structure. Furthermore, the grooves 34 may have various plan-view shapes, such as a straight-line shape, a cross shape, and a lattice shape.

The plan-view shape of the grooves 34 and the depth of the grooves 34 corresponding to the plan-view shape of the grooves 34 are decided to prevent the generation of air bubbles while receiving a predetermined amount of fluorescent paste.

The dispenser (not shown) is reciprocated between the opposite edge parts of the rear glass substrate 32 to apply the fluorescent paste into the discharge cells between the partition walls 31.

Since the initial application amount of the fluorescent paste discharged from the dispenser is not uniform, the auxiliary partition walls 33 having the grooves 34 formed at the upper parts thereof must be formed at the edge of the rear glass substrate 32 where the application of the fluorescent paste is initiated.

Specifically, the auxiliary partition walls 33 having the grooves 34 are positioned at the upper surface of the edge of the rear glass substrate 32 on the application route of the dispenser.

Hereinafter, a method of manufacturing the plasma display panel according to the present invention will be described.

First, a plurality of partition walls 31 are formed along address electrodes of a rear glass substrate 32 such that the partition walls 31 are arranged at predetermined intervals, and auxiliary partition walls 33 are formed between the neighboring partition walls 31 on the rear glass substrate 32.

Subsequently, groove-forming photosensitive paste having a predetermined height is applied to the edge regions of the top surfaces of the auxiliary partition walls 33, and then the groove-forming photosensitive paste is dried, so as to form grooves 34 at the upper parts of the auxiliary partition walls 33.

Here, the groove-forming photosensitive paste may be partially formed at the edge regions of the top surfaces of the auxiliary partition walls 33, as shown in FIG. 3A, such that the grooves are constructed in an open-type structure. Alternatively, the groove-forming photosensitive paste may be entirely formed at the edge regions of the top surfaces of the auxiliary partition walls 33, as shown in FIG. 4, such that the grooves are constructed in a closed-type structure.

The groove-forming photosensitive paste is obtained by preparing inorganic particles and organic components in a predetermined composition and uniformly mixing the preparation using a roller or a mixer. The photosensitive paste is used to form the grooves 34.

The formed grooves 34 receive the initial application amount of fluorescent paste to prevent the fluorescent paste from flowing out of the auxiliary partition walls 33.

In another embodiment of the present invention, a plurality of partition walls 31 are formed along address electrodes of a rear glass substrate 32 such that the partition walls 31 are arranged at predetermined intervals, and auxiliary partition walls 33 are formed between the neighboring partition walls 31 on the rear glass substrate 32.

Subsequently, masks having a predetermined pattern are formed on the top surfaces of the auxiliary partition walls 33, and then the upper parts of the auxiliary partition walls 33 are partially etched to a predetermined thickness according to the pattern of the masks such that grooves are formed at the upper parts of the auxiliary partition walls 33.

As apparent from the above description, the plasma display panel according to the invention has effects in that grooves having a desired pattern are formed at the upper parts of the auxiliary partition walls using the groove-forming photosensitive paste, or the auxiliary partition walls are etched using the mask pattern so as to form grooves having a desired pattern.

Furthermore, the plasma display panel according to the invention has effects in that the initial application amount of fluorescent paste, which is not uniform, is received in the grooves formed at the upper parts of the auxiliary partition walls, whereby the fluorescent paste is uniformly applied into the discharge cells.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A plasma display panel comprising:
a plurality of partition walls formed on a substrate such that the partition walls are arranged at predetermined intervals;
auxiliary partition walls formed between the neighboring partition walls on the substrate; and
at least one groove, having a predetermined depth, formed at the upper part of each auxiliary partition wall.

2. The plasma display panel according to claim 1, wherein
the auxiliary partition walls are arranged in the direction perpendicular to the longitudinal direction of the partition walls, and
the auxiliary partition walls are spaced a predetermined distance from opposite ends of the partition walls toward the middles of the partition walls.

3. The plasma display panel according to claim 2, wherein the predetermined distance is approximately 0.5 mm or more.

4. The plasma display panel according to claim 1, wherein the top surfaces of the auxiliary partition walls have a height lower than that of the top surfaces of the partition walls.

5. The plasma display panel according to claim 1, wherein the difference in height between the auxiliary partition walls and the partition walls is approximately 2 to 30 um.

6. The plasma display panel according to claim 1, wherein the grooves have side surfaces perpendicular to the bottom surfaces of the grooves.

7. The plasma display panel according to claim 1, wherein the grooves have side surfaces at a predetermined angle to the bottom surfaces of the grooves.

8. The plasma display panel according to claim 1, wherein the grooves have flat bottom surfaces.

9. The plasma display panel according to claim 1, wherein each groove has a bottom surface at which at least one sub groove is formed such that the bottom surface of each groove is formed in a concavo-convex shape.

10. The plasma display panel according to claim 1, wherein the grooves are constructed in an open-type structure in which the circumferences of the grooves are partially opened to the outside.

11. The plasma display panel according to claim 10, wherein the side surfaces of the partition walls are located at the opened regions of the open-type structure grooves.

12. The plasma display panel according to claim 1, wherein the depth of the grooves is approximately 1 to 90 um from the top surfaces of the grooves.

13. The plasma display panel according to claim 1, wherein the grooves receive the initial application amount of fluorescent paste so as to accomplish uniform application of the fluorescent paste.

14. A plasma display panel comprising:
a plurality of partition walls formed on a substrate such that the partition walls are arranged at predetermined intervals;
auxiliary partition walls formed on a non-discharge region of the substrate; and
at least one groove, having a predetermined depth, formed at the upper part of each auxiliary partition wall.

15. The plasma display panel according to claim 14, wherein the partition wall divides into fluorescent regions that are different from each other.

16. The plasma display panel according to claim 14, wherein a fluorescent paste is formed in the auxiliary partition walls.

17. The plasma display panel according to claim 14, wherein the auxiliary partition walls have a height lower than the partition walls.

18. The plasma display panel according to claim 14, wherein the auxiliary partition walls have a width wider than the partition walls.

19. The plasma display panel according to claim 14, wherein the auxiliary partition walls are arranged at least one end region to the longitudinal direction of the partition walls.

20. A method of manufacturing a plasma display panel, comprising:
forming a plurality of partition walls on a substrate such that the partition walls are arranged at predetermined intervals;
forming auxiliary partition walls between the neighboring partition walls on the substrate; and
forming grooves at the upper parts of the auxiliary partition walls to a predetermined depth.

21. The method according to claim 20, wherein the step of forming grooves includes:
applying groove-forming paste having a predetermined height to the edge regions of the top surfaces of the auxiliary partition walls; and
drying the groove-forming paste to form grooves at the upper parts of the auxiliary partition walls.

22. The method according to claim 21, wherein the groove-forming paste is entirely formed at the edge regions of the top surfaces of the auxiliary partition walls such that the grooves are constructed in a closed-type structure.

23. The method according to claim 21, wherein the groove-forming paste is partially formed at the edge regions of the top surfaces of the auxiliary partition walls such that the grooves are constructed in an open-type structure.

24. The method according to claim 20, wherein the step of forming grooves includes:
forming masks having a predetermined pattern on the top surfaces of the auxiliary partition wall; and
partially etching the upper parts of the auxiliary partition walls to a predetermined thickness according to the pattern of the masks such that grooves are formed at the upper parts of the auxiliary partition walls.
